(19) United States
(12) Patent Application Publication
(10) Pub. No.: US 2016/0123648 A1
(43) Pub. Date: May 5, 2016

(54) Light Weight Reinforced Ice Chest

(71) Applicant: Thomas E. Leaverton, Monroe, LA (US)

(72) Inventor: Thomas E. Leaverton, Monroe, LA (US)

(21) Appl. No.: 14/927,702

(22) Filed: Oct. 30, 2015

Related U.S. Application Data
(60) Provisional application No. 62/073,397, filed on Oct. 31, 2014.

(51) Int. Cl. F25D 3/08; B65D 81/38; B62B 5/00; F25D 23/06

(52) U.S. Cl. CPC F25D 3/08; F25D 23/066; B65D 81/3816; B62B 5/00

(57) ABSTRACT

A lightweight reinforced ice chest is discussed herein comprising a thermally insulated polystyrene foam body which is polygonal in shape being further comprised of a base connected to two pairs of opposing sides defining a top opening, and wherein a carrying handle is located on either of two of a selected pair of opposing sides of the ice chest. Either or both the interior and exterior of the body are coated with a polyurea spray lining to increase the durability and insulation of the polystyrene foam. The ice chest further has a lid having an exterior and an interior which is movable between an open and a closed position with respect to the top opening.

### CROSS REFERENCE TO RELATED APPLICATIONS

This application claims priority to U.S. Provisional Patent Application No. 62/073,397, entitled “Light Weight Reinforced Ice Chest,” which was filed on Oct. 31, 2014.

### STATEMENT REGARDING FEDERALLY SPONSORED RESEARCH OR DEVELOPMENT

Not Applicable.

### REFERENCE TO A “SEQUENCE LISTING,” A TABLE, OR A COMPUTER PROGRAM

Not Applicable.

### BACKGROUND

The present invention relates to the design of an ice chest or cooler which has been reinforced with a polyurea lining so as to increase the strength and durability of the ice chest without significantly or noticeably adding to the weight of the ice chest.

The uses of ice chests or coolers is well known in the prior art. Ice chests generally vary in form, shape, and composition. The problem posed in this field of invention is to provide an ice chest which is practical, economical and such that it will appeal to manufacturers, retailers and users. Ice chests generally vary in shape, form, composition, and price. Ice chests are by their nature designed to be portable. Therefore, ice chests must be made of materials which are generally light weight and is capable of insulating the contents of the ice chest while maintaining a structured shape. Typical components for ice chests are formed from foam materials such as polystyrene and polymers such as plastics.

One of the most recognizable and economical ice chests is the simple box chest formed of polystyrene foam. The typical polystyrene foam ice chest is extremely light weight and inexpensive to manufacture. However, the tradeoff is that the polystyrene foam materials are not durable and are suspect to tears, fractures, and punctures caused by the weight of the contents or external forces. Therefore, the polystyrene foam chests rarely hold up to normal wear and tear, causing them to often be treated as disposable ice chests. The disposable nature of these chests is problematic to a consumer from an economic standpoint and is also problematic from an environmental standpoint as the polystyrene foam often ends up in a landfill, unable to be recycled.

Furthermore, typical polystyrene foam has a rough porous surface which alone would render it a difficult medium to paint. However, polystyrene foam also readily reacts with many paints such as spray paint, causing the polystyrene foam to deform when exposed to the paint. These factors render the painting and decorating of a traditional polystyrene foam ice chest difficult and expensive as specialty paints and techniques are required to overcome these shortcomings.

An object of the invention is to structurally, functionally, and otherwise improve upon these ice chests without significantly increase the weight or cost of the ice chest. The resulting ice chest remains both economical to produce, light weight, and paintable, while also obtaining an enhanced level of durability in terms of both tensile strength and puncture prevention.

### DESCRIPTION OF THE DRAWINGS

The drawings constitute a part of this specification and include exemplary embodiments of the reinforced ice chest 0, which may be embodied in various forms. It is to be understood that in some instances, various aspects of the invention may be shown exaggerated or enlarged to facilitate an understanding of the invention. Therefore, the drawings may not be to scale.

FIG. 1 is a frontal view of a polystyrene foam ice chest 0 lined with a polyurea substrate 9 to reinforce the strength of the ice chest 0. FIG. 2 is a cross sectional view of an alternate embodiment of the present invention with an axel running through a chassis near the base of the ice chest 0. FIG. 3 is a top view of a lid 3 to the ice chest 0 which is also lined with polyurea.

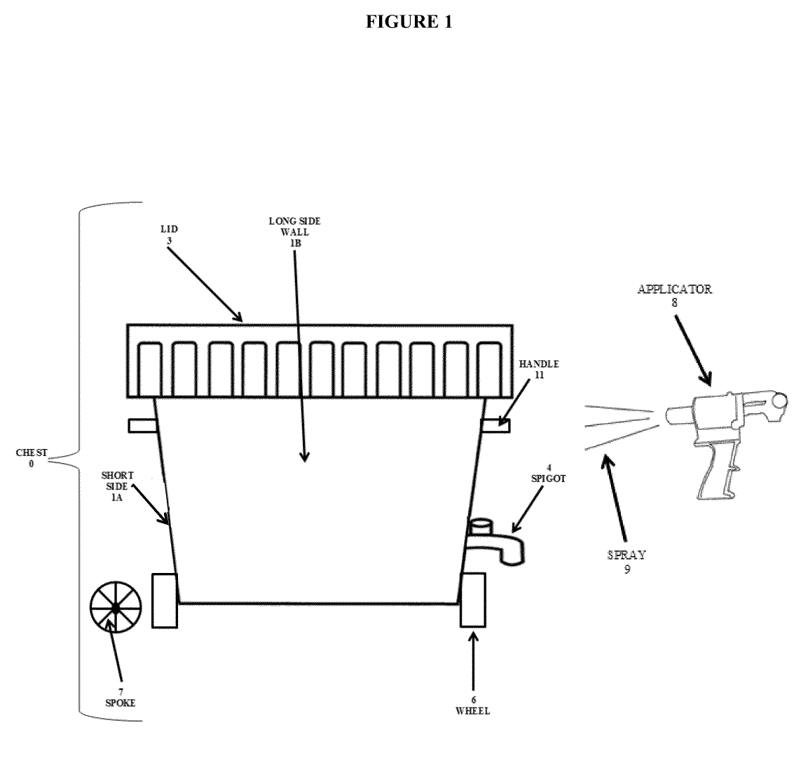

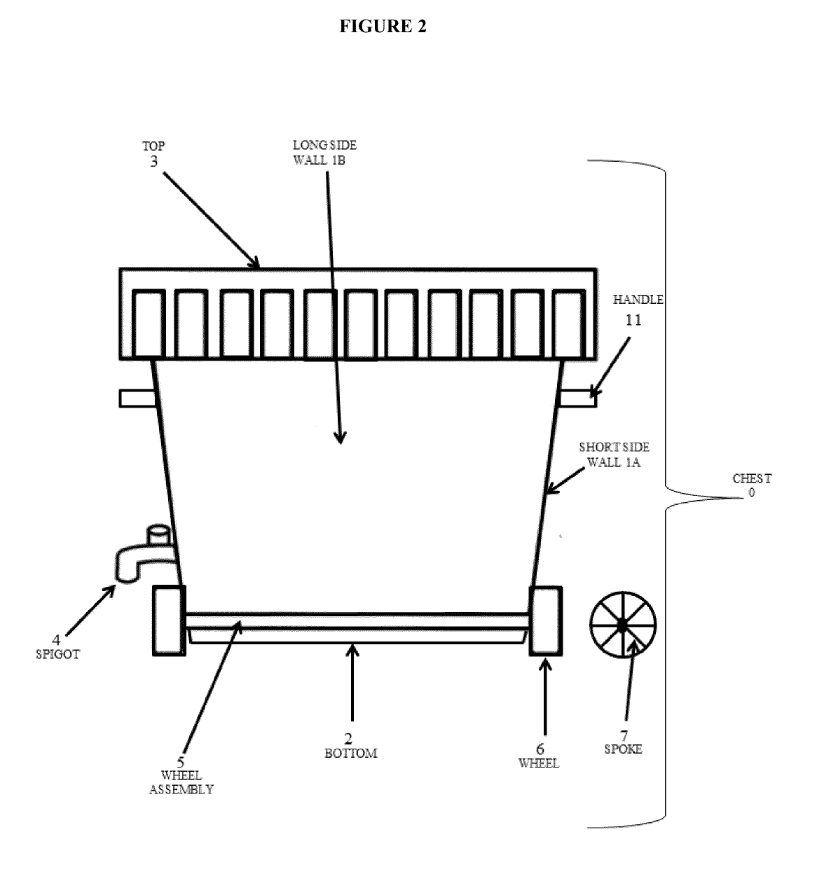

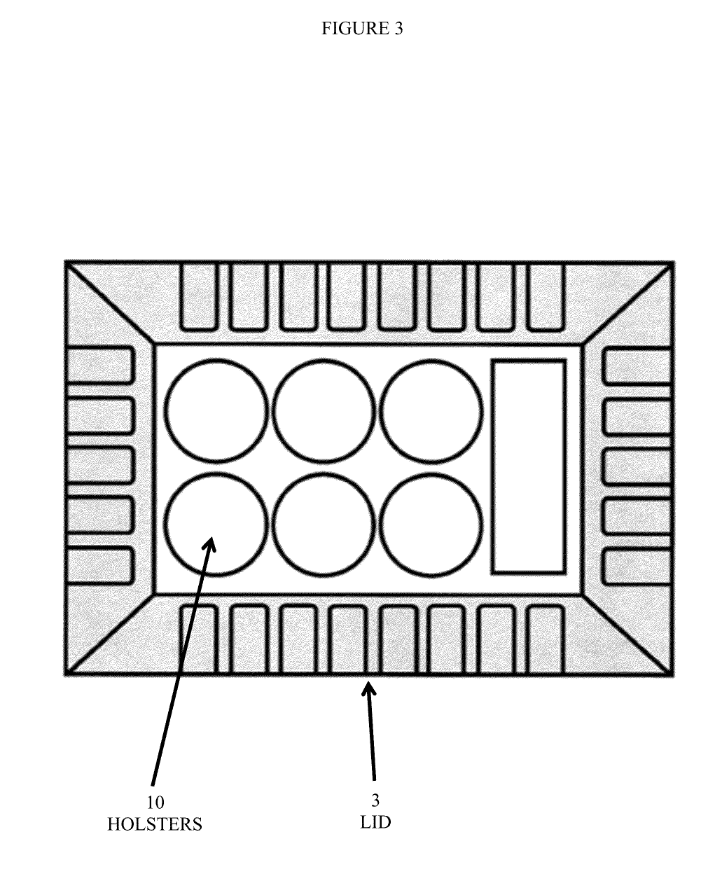

### DETAILED DESCRIPTION

The subject matter of the present invention is described with specificity herein to meet statutory requirements. However, the description itself is not intended to necessarily limit the scope of claims. Rather, the claimed subject matter might be embodied in other ways to include different steps or combinations of steps similar to the ones described in this document, in conjunction with other present or future technologies. Although the terms “step,” “next,” or “then” might be used herein to connote different components of methods or systems employed, the terms should not be interpreted as implying any particular order among or between various steps herein disclosed unless and except when the order of individual steps is explicitly described. Indeed the steps described herein may vary in order depending on the particular embodiment described.

Furthermore, the described features, structures, or characteristics may be combined in any suitable manner in one or more embodiments. In the following description, numerous specific details are provided, such as examples of polyurea resins, densities of polyurea sprays and layers, foam polymers, side walls, lids, bases, and other components. One skilled in the relevant art will recognize, however, that the reinforced ice chest 0 may be practiced without one or more of the specific details, or with other methods, components, materials, and so forth. In other instances, well-known structures, materials, or operations are not shown or described in detail to avoid obscuring aspects of the invention.

For the purpose of understanding the lightweight reinforced ice chest 0 references are made in the text to exemplary embodiments of a lightweight reinforced ice chest 0, only some of which are described herein. It should be understood that no limitations on the scope of the invention are intended by describing these exemplary embodiments. One of ordinary skill in the art will readily appreciate that alternate but functionally equivalent components, materials, designs, and equipment may be used. The inclusion of additional elements may be deemed readily apparent and obvious to one of ordinary skill in the art. Specific elements disclosed herein are not to be interpreted as limiting, but rather as a basis for the claims and as a representative basis for teaching one of ordinary skill in the art to employ the present invention.

The reinforced ice chest 0 described herein includes a thermally insulated body having a base 2, an exterior and an initially open interior which defines a top opening for the ice chest 0 body. The ice chest 0 has a lid 3 having an exterior and an interior which is movable between an open and a closed position with respect to the top opening. In various embodiments, a latching means is provided for holding the lid 3 in the closed position can comprise clips, clasps, bands, friction fit, snaps or other mechanical means. In an embodiment of the ice chest 0, the ice chest body 0 comprises a polystyrene foam and a layer of polyurea spray 9 is applied to at least one of either the interior or the exterior of the ice chest 0 body. When the polyurea spray 9 dries, it forms a clear layer on the ice chest 0, sealing the ice chest 0 and adding thermal and physical resiliency qualities

In one embodiment, the ice chest 0 body comprises polystyrene foam and is polygonal in shape being comprised of a base 2 connected to two pairs of opposing sides walls 1, and wherein a carrying handle 11 is located on either of two of a selected pair of opposing sides 1 of the ice chest 0. The handle 11 can either be shaped into the polystyrene foam or can otherwise be externally mounted to the ice chest 0. Both the interior and exterior of the side walls 1 and base 2 are coated with a lining of polyurea spray 9 to increase the durability and insulation of the polystyrene foam. In alternate embodiments, a polyurea or polyol hybrid or derivative may be used, particularly if the hybrid is devoid of volatile organic compounds. Moreover, in various embodiments, the side walls 1 may be of substantially equivalent sides whereas in others it may comprise a pair of shorter opposing side walls 1A connected to a pair of short side walls 1B.

Polyurea is an elastomer that is derived from the reaction product of an isocyanate component and a synthetic resin component. For example, some pure polyureas are made from the reaction of resin components comprising tertiary amine compounds and isocyanate at a 1:1 ratio. Pure polyurea contains several attributes which make it ideal for use in an ice chest. Unlike many hybrid polyureas which are similar to polyurethane, a pure polyurea is completely absent of volatile organic compounds and has superior tensile strength in the form of both elongation and impact resistance. Therefore, dried polyurea is safe to use in the proximity of foods and other consumables which are typically contained in an ice chest. Likewise, objects sprayed with a layer of polyurea benefit from increased durability and tensile strength.

Lining a polystyrene foam ice chest 0 with a polyurea spray creates a waterproof layer encapsulating the polystyrene foam while also imparting strengthening properties to the polystyrene foam structure itself. By lining the inside of the ice chest 0 with the polyurea spray, the polystyrene foam side walls 1, base 2 and lid 3 are protected by the waterproof layer, preventing liquids contained in the ice chest 0 from contacting the polystyrene foam whereby it will degrade the structural integrity of the polystyrene foam over time. Likewise, the polystyrene foam structure will evidence increased durability and tensile strength, protecting the foam from normal punctures and caving issues caused by the contents of the ice chest 0 and the weight thereof. Lining the exterior of the ice chest 0 with polyurea spray 9 likewise protects the polystyrene foam material from the elements, including moisture and external factors and further increases the strength and durability of the polystyrene foam structure. Furthermore, the waterproof layer allows for the exterior and/or interior of the ice chest body 0 to be readily painted, whereas the rough porous surface of a traditional polystyrene foam ice chest renders painting difficult and expensive. The same features which render the ice chest capable of being painted also renders the ice chest easier to be cleaned.

Various methods could be used to properly coat the ice chest body 0 with a pure 100% polyurea spray 9 or other suitable polyurea based compound. In one embodiment of the method for assembly, the ice chest 0 is assembled by strategically applying the polyurea foam 9 to the corners of the base 2 and to the seams or locations wherein the side walls 1 connect to the base 2 and to each other at a thickness of 50 mils to strengthen the seams. Next, the entirety of the interior is sprayed with polyurea spray 9 at 30 mils to provide a waterproof layer and to strengthen the base 2 and side walls 1. In an embodiment wherein both the interior and exterior is lined, the polyurea spray 9 is then applied to the exterior of the of the ice chest body 0 at 30 mils. One having ordinary skill in the art would recognize that varying densities of polyurea spray 9 could be applied to the ice chest 0 or to different components of the same ice chest body 0 depending on the desired result. For example, the base 2 and seams may be coated at 50 mils while the side walls 1 may be coated at 30 mils. In alternate embodiments, the entire structure may be coated at a uniform thickness. Once the layer of the polyurea spray 9 has dried, the waterproof finished ice chest 0 is optionally painted or decorated. The paint and decorations to be applied are a matter of design choice.

The increased durability of the polystyrene foam ice chest 0 allows for the ice chest 0 to utilize features which have traditionally been reserved to hard body ice chests 0 such as plastic ice chests 0 due to the limited durability of traditional foam ice chests 0. Such features include drains, wheels, pull handles, telescoping handles, plugs, hinged tops, coasters for sliding, cupholders, and the like. Turning to FIG. 2, by way of illustration, the versatility of the present invention is further illustrated herein in an alternate embodiment wherein a drain 4 is included in at least one of the side walls 1. A typical polystyrene foam ice chest 0 would generally not be able to incorporate a drain 4 because the drain 4 would diminish the structural integrity of the polystyrene foam wall and would further allow water to seep into the polystyrene foam. However, the present invention does not suffer from those limitations. In alternate embodiments, the drain 4 can be formed in the side wall 1 before or after the side wall 1 is lined with its first coat of polyurea spray 9. A hole is formed in the side wall 1 in a position substantially near the base 2 of the ice chest 0. The formed opening and the surrounding areas of the side wall 1 is then sprayed with the polyurea spray 9 so as to strengthen the side walls 1 of the opening. Next, an adjustable plug 13 is mounted into the drain 4 opening which is capable of controlling the flow of liquids exiting the interior of the ice chest 0. An additional layer of polyurea spray 9 may be applied to the plug 13 area in alternate embodiments to provide additional durability to the area. Moreover, turning back to FIG. 2, it is shown that the additional strength added by the polyurea spray 9 also allows for the ability to mount a wheel system into or onto the ice chest 0. One embodiment of the wheel system may comprise, generally, at least two wheels 6 that are connected via a wheel assembly shaft 5. In the depicted embodiment, the wheel assembly shaft 5a extends through each of one set of opposing side walls 1 and through the base 2; however, it is conceivable that the wheels could also be externally mounted to the ice chest 0. Wheels 6 are connected on each opposing side of the drive shaft which connects to the wheels through spoke 7. In such an embodiment, it may be advantageous to also attach a pullable handle (not depicted) such as a telescoping handle. Without the addition of the polyurea resin spray, the polystyrene foam would lack the durability to utilize these features often reserved for more durable materials such as plastic ice chests.

In an additional embodiment, the lid 3 is sprayed with a layer of polyurea spray 9 to increase its strength, durability, and insulation. In a variation of the same embodiment, both the lid 3 and the body of the ice chest 0 are lined with polyurea spray 9, creating a lid 3 of sufficient tensile strength to allow a user to use the ice chest 0 to be utilized as a step or seat as a result of the increased strength and stability.

Reference throughout this specification to features, advantages, or similar language does not imply that all of the features and advantages that may be realized should be or are in any single embodiment. Rather, language referring to the features and advantages is understood to mean that a specific feature, advantage, or characteristic described in connection with an embodiment is included in at least one embodiment. Thus, discussion of the features and advantages, and similar language, throughout this specification may, but do not necessarily, refer to the same embodiment.

Furthermore, the described features, advantages, and characteristics may be combined in any suitable manner in one or more embodiments. One skilled in the relevant art will recognize that the lightweight reinforced ice chest may be practiced without one or more of the specific features or advantages of a particular embodiment. In other instances, additional features and advantages may be recognized in certain embodiments that may not be present in all embodiments.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment.

It should be understood that the drawings are not necessarily to scale; instead, emphasis has been placed upon illustrating the principles of the invention. In addition, in the embodiments depicted herein, like reference numerals in the various drawings refer to identical or near identical structural elements.

Moreover, the terms “substantially” or “approximately” as used herein may be applied to modify any quantitative representation that could permissibly vary without resulting in a change to the basic function to which it is related.

1. An ice chest comprising:
a. a thermally insulated body having a base, an exterior and an initially open interior which defines a top opening for the body; and,
b. a lid having an exterior and an interior which is movable between an open and a closed position with respect to the top opening;
c. wherein at least one of said exterior or interior of the thermally insulated body is lined with a polyurea coating.

2. The ice chest of claim 1 wherein the thermally insulated body comprises a polystyrene foam.

3. The ice chest of claim 2 wherein at least one of said exterior or interior of the thermally insulated body is lined with a polyurea spray coating that is at least 30 mils in thickness.

4. The ice chest of claim 2 wherein at least one of said exterior or interior of the thermally insulated body is lined with a polyurea spray coating that is at least 50 mils in thickness.

5. The ice chest of claim 2 wherein the thermally insulated body further comprises two sets of opposing side walls, each with an interior and exterior side, wherein at least one of the interior or exterior sides is lined with a polyurea coating that is at least 30 mils in thickness.

6. The ice chest of claim 5 wherein the sets of opposing side walls are joined at seams between each set of opposing side walls, and wherein the seams are coated with a polurea lining that is at least 30 mils in thickness.

7. The ice chest of claim 6 wherein the seams are coated with a polyurea lining that is at least 50 mils in thickness.

8. The ice chest of claim 2 wherein the exterior of the base is lined with a polyurea spray coating that is at least 50 mils in thickness.

9. The ice chest of claim 5 wherein the exterior of the base is lined with a polyurea spray coating that is at least 50 mils in thickness.

10. The ice chest of claim 1 further comprising a means for removably holding the lid in the closed position.

11. The ice chest of claim 2 further comprising a drain in the thermally insulated body.

12. The ice chest of claim 2 further comprising a wheel assembly.

13. The ice chest of claim 12 wherein the wheel comprises a shaft and two wheels, and wherein the base further comprises a channel diametrically larger than the shaft that transcends from one side of the base to the opposing side; wherein the shaft extends through the channel in the base and wherein one wheel is connected to each side of the shaft.

14. An ice chest comprising a thermally insulated body with an interior and exterior comprising a base connected to two pairs of opposing sides, and wherein a carrying handle is located on each of at least one selected pair of opposing sides of the ice chest and wherein both the interior and exterior of the sides and base are coated with a polyurea spray lining to increase the durability and insulation of the polystyrene foam.

15. The ice chest of claim 14 wherein the thermally insulated body further comprises polystyrene foam.

16. The ice chest of claim 15 wherein the sets of opposing side walls are joined at seams between each set of opposing side walls, and wherein the seams are coated with a polurea lining that is at least 50 mils in thickness.

17. The ice chest of claim 16 wherein the the base is lined with a polyurea spray coating that is at least 50 mils in thickness.

18. The ice chest of claim 15 wherein the exterior of the base is lined with a polyurea spray coating that is at least 50 mils in thickness.

19. The ice chest of claim 15 further comprising a drain in the thermally insulated body.

20. The ice chest of claim 15 further comprising a wheel assembly wherein the wheel comprises a shaft and two wheels, and wherein the base further comprises a channel diametrically larger than the shaft that transcends from one side of the base to the opposing side; wherein the shaft extends through the channel in the base and wherein one wheel is connected to each side of the shaft.
